(19) United States
(12) Patent Application Publication
(10) Pub. No.: US 2008/0264295 A1
(43) Pub. Date: Oct. 30, 2008

(54) Treatment of Metakaolin

(75) Inventors: Richard James Taylor, Cornwall (GB); Darren Francis Grose, Cornwall (GB)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: IMERYS MINERALS LIMITED, PAR, CORNWALL (GB)

(21) Appl. No.: 11/815,932

(22) PCT Filed: Feb. 7, 2006
(86) PCT No.: PCT/GB2006/000427

§ 371 Date: Dec. 10, 2007

(30) Foreign Application Priority Data
Feb. 9, 2005 (GB) 0502656.2

(51) Int. Cl. C09D 11/00; C09C 1/00

(52) U.S. Cl. 106/31.13; 106/416

(57) ABSTRACT

A method for increasing the brightness of metakaolins comprises calcining a metakaolin under reducing conditions. The calcined metakaolins are suitable for use in a variety of applications including in polymer products and paints.

### FIELD OF THE INVENTION

The present invention relates to methods for increasing the brightness of metakaolins and products obtained from said methods. The present invention also relates to high brightness, low yellowness metakaolins having a low relative density which may be made according to the methods of the present invention. The brightened metakaolins may be used in a variety of applications, including as pigments in paper and polymer products.

### BACKGROUND OF THE INVENTION

Calcined kaolins find use in a variety of application compositions including compositions for making paints, plastics, rubbers, inks, sealants, ceramics, cementitious products, paper and coatings. In these applications, they impart to the finished products a number of desirable properties such as brightness, opacity, hiding power, strength (in plastics) and friction (in paper).

The major constituent of kaolin is kaolinite, which has the general formula Al₂(OH)₄Si₂O₅. The process of calcination removes hydroxyl ions. Depending on the conditions used, the chemical change may be partial or total. This is typically determined by controlling the temperature at which calcination takes place. Typically, and depending on the nature of the particular sample, at about 450-650° C., the kaolin undergoes a strongly endothermic dehydration reaction resulting in the conversion to material known as metakaolin. The metakaolin state can be conveniently ascertained by acid solubility testing because the alumina in the clay (from Al₂O₃.2SiO₂) is virtually completely soluble in strong mineral acid.

Despite the numerous advantages afforded by the use of calcined kaolins, there are also a number of disadvantages associated with their use. When compared with uncalcined kaolins they are relatively abrasive, which can result in increased wear of web forming screens (wires) on paper making machines, dulling of paper slitter knives, wear of printing plates when they come in contact with coated paper containing fine calcined pigments in the coating formulation, and, in general, wear of any surface that comes in contact with these pigments.

To overcome at least the abrasion problem, it is known to calcine the kaolin pigments at temperatures less than those required to produce pigments generally referred to by those skilled in the art as “fully calcined” pigments and control the calcination temperature so that the kaolin undergoes the characteristic endothermic dehydration reaction mentioned above, and the original kaolinite is only partially dehydroxylated, thus forming metakaolin.

However, it is well known that the brightness of a metakaolin pigment is typically inferior, generally by about 2-3%, than that of fully calcined pigments derived from the same clay calciner feed. Thus, the fully calcined version gives greater brightness, but generally with poor abrasion characteristics and with associated higher operating costs. The metakaolin has generally lower abrasion, but brightness is also generally inferior.

It is known to bleach hydrous clays in order to increase their brightness. Typically, kaolin clays are bleached with bleaches such as hydrosulfite salts to provide clay products of increased brightness and value. However, it is generally not considered likely that bleaching processes will result in a significant increase in the brightness of calcined kaolins.

GB1181491 describes a process whereby a metakaolin may be calcined to yield a white pigment. Calcination is described as taking place in a conventional calcining furnace such as the Nichols-Herrschoff calcining furnace. In such a system, large airflows are required resulting in an oxidising atmosphere.

The present invention is based on the finding that metakaolin may be calcined under reducing conditions, resulting in a metakaolin of increased brightness. It has also been found that advantageously the increase in brightness may be accompanied by a decrease in yellowness or at least an increase in yellowness which is less than that normally associated with calcining techniques.

### SUMMARY OF THE INVENTION

In a first aspect, the present invention provides a method of treating or brightening a metakaolin comprising calcining the metakaolin under reducing conditions. The reducing conditions are such that the atmosphere in the calciner in which the metakaolin is being calcined is reducing. The calcining of the metakaolin under reducing conditions may be referred to as a secondary calcination.

Preferably the treating or brightening of the metakaolin results in an ISO brightness increase of at least 0.3 units. More preferably the ISO brightness increase is at least 0.5 units or at least 1.0 unit. Even more preferably, the ISO brightness increase is at least 2.0 units or 3.0 units. Most preferably, the brightening of the metakaolin results in an ISO brightness increase of at least 5.0 units.

Preferably, treating or brightening of the metakaolin is accompanied by a decrease in yellowness of the metakaolin. For example, treatment of the metakaolin may result in a yellowness decrease of at least 0.1 unit, more preferably at least 0.2 units and most preferably at least 0.5 units.

The reducing conditions employed in the calcination of the metakaolin are typically such that iron (III) species present on the metakaolin are reduced to a lower oxidation state such as iron (II) species. More generally, the whiteness of the metakaolin may be increased by reducing the impact of discolouring species.

Preferably, the calcining of the metakaolin (or secondary calcination) is carried out in the presence of a secondary fuel. The secondary fuel contributes to the reducing effect of the atmosphere in the calciner during secondary calcination of the metakaolin. Suitable examples of the secondary fuel include carbon, preferably in the form of charcoal, fuel oil and vegetable oils. The use of a secondary fuel is particularly advantageous in reducing the yellowness of the metakaolin or at least giving rise to acceptable levels of yellowness.

The calcined metakaolin according to the present invention may be subjected to further processes in order to increase its brightness. For example the calcined metakaolin may be subjected to bleaching. Preferably the further bleaching comprises (a) forming a dispersed aqueous slurry of the calcined metakaolin and (b) contacting a bleaching agent with the slurry formed in (a). The slurry in (a) may be homogenised using any one of a number of standard techniques. Prior to (b) and/or after (b) the pH may be measured and optionally may be adjusted. Preferably, the bleaching agent and slurry are mixed thoroughly. Adjustment of the pH is achieved by the use of any one of a number of standard reagents for decreasing or increasing the pH and suitable alkalis and acids will be readily apparent to persons skilled in the art. Of particular use are sodium carbonate, sulphuric acid, phosphoric acid, sodium hydroxide, calcium hydroxide, calcium carbonate, potassium hydroxide, potassium carbonate and combinations thereof. Adjustment of the pH during the bleaching process may contribute to the enhancement or optimisation of the bleaching process.

Following bleaching, the slurry of bleached calcined metakaolin may be filtered using any one of a number of standard techniques and may be dried to yield the brightened, bleached calcined metakaolin product. Typical drying conditions are such that the bleached calcined metakaolin is dried to near dryness, which corresponds to the bleached calcined metakaolin comprising about 20 wt % moisture. Typically, in order to achieve near dryness, drying will take place at 50 to 600° C. The range of temperatures used in the drying process may depend on the method of drying used. For example, gas burners may be used to dry the bleached calcined metakaolin which feed in air at high temperatures, for example 600° C. As the air becomes laden with water, the air may be rapidly cooled, for example to below 100° C.

Preferably, the bleaching is reductive bleaching. Preferably the bleaching agent is used under such conditions whereby any remaining iron (III) species present on the calcined metakaolin are reduced to a lower oxidation state such as iron (II) species. Typically, the reduced iron species will be readily removed from the calcined metakaolin by the bleaching process, due to the increased solubility of the reduced iron species in the bleaching solution when compared with the iron (III) species. The reducing bleaching agent may, for example, be selected from sodium hydrosulphite, sodium dithionite, formamidine sulphinic acid (FAS), and borohydride, for example sodium borohydride. For most calcined metakaolins, a reducing agent dose rate of about 5 parts per thousand (conventionally expressed as kg per tonne) by weight of dry calcined metakaolin is sufficient to produce a maximum brightness value. In the case of reductive bleaching, the value of pH may be adjusted to alter the solubility of the discolouring iron species and to prevent rapid degradation of the bleaching chemicals. More specifically, the value of pH may be such that the rate of hydrolysis of the bleaching chemicals is reduced or minimised.

The calcined metakaolin, prepared according to the invention, (and which has optionally been bleached), may be subjected to light comminution, e.g. grinding or milling. The calcined metakaolin may be treated by a known particle size classification procedure, e.g. screening and/or centrifuging, and/or by air classification to obtain particles having a desired d₅₀ value. The calcined metakaolin typically has a value of d₅₀, as derived from equivalent spherical diameter (esd) measurements, in the range of 0.1 to 20 μm, for example 0.1 to 10 μm. Preferably, the value of d₅₀ is in the range 1 to 5 μm, for example about 2.2 μm. The esd measurements are made in a well known manner by sedimentation of the particulate material in a fully dispersed condition in an aqueous medium using a sedigraph 5100 machine as supplied by Micromeritics Instruments Corporation, Norcross, Ga., USA, referred to herein as a “Micromeritics Sedigraph 5100 unit”. Such a machine provides measurements and a plot of particle size versus the cumulative percentage by weight of particles having an esd less than the respective particle size.

The present invention also provides high brightness, low yellowness metakaolins having a low relative density. More specifically, according to a second aspect of the present invention, metakaolins having a relative density less than about 2.2, an ISO brightness of greater than about 88 and a yellowness of less than about 3.5 are provided. The metakaolin may have a relative density of about 2.15 or less, for example, less than 2.10 or less than 2.05 or less than 2.0 or less than 1.95. The metakaolin may, for example, have a relative density greater than about 1.90 or 1.95. Typically, the relative density of the metakaolin may be in the range of about 1.95 to 2.15. The metakaolin according to this aspect of the invention may have an ISO brightness greater than about 88.5, for example greater than 89.0 or greater than 89.5 or greater than 90.0 or greater than 90.5. The metakaolin may have a yellowness less than 3.5, preferably 3 or less, for example less than 2 or less than 1 and be as low as 0.1. The value of yellowness may lie in the range 0.1 to 3, for example 1 to 3 or 2 to 3.

Preferably the relative density of the metakaolin according to the second aspect of the invention is about 2.06, for example 2.06+/−0.6. Preferably the low relative density metakaolin is Opacilite™ which is commercially available from Imerys Minerals Ltd.

The ISO brightness, as expressed herein, refers to the percentage reflectance to light of a 457 nm wavelength. A suitable method for measuring the ISO brightness according to the present invention is set out in the test method in the Examples herein.

The metakaolin according to the second aspect of the present invention may be made according to the method of the first aspect of the present invention.

The metakaolin products according to the present invention, i.e. the calcined metakaolins resulting from the methods according to the first aspect of the present invention and the metakaolins according to the second aspect of the invention are suitable for use in a wide range of applications and in a further aspect of the present invention the metakaolin products according to the present invention, may be supplied for use as pigment additives in a filler or coating composition. For example, the metakaolin products according to the present invention may be added to a paper making composition to provide filler particles for the paper making fibres or may be added to a paper coating composition. Further examples include use of the metakaolin products according to the present invention in inks, paints, ceramics, polymer products, rubber products and barrier coating compositions.

In a further aspect of the present invention, products obtained according to the methods of the present invention are also provided, namely, polymers, paints, inks, rubber products, paper products, paper coating compositions, coated papers, barrier coating compositions and ceramics, all comprising the metakaolin products obtained according to the present invention.

### DETAILED DESCRIPTION OF THE INVENTION

### The Metakaolin

Calcined kaolins are kaolins that have been converted from the corresponding (naturally occurring) hydrous kaolin to the dehydroxylated form by thermal methods. Calcination changes the kaolin structure from crystalline to amorphous. The degree to which hydrous kaolin undergoes changes in crystalline form may depend on the amount of heat to which it is subjected. Initially, dehydroxylation of the hydrous kaolin occurs on exposure to heat. At temperatures below about 850-900° C., the product is considered to be virtually dehydroxylated with the resultant amorphous structure commonly being referred to as being a metakaolin. Frequently, calcination at this temperature is referred to as partial calcination and the product may also be referred to as a partially calcined kaolin. Further heating to temperatures above about 900-950° C. results in further structural changes such as densification. Calcination at these higher temperatures is commonly referred to as being full calcination and the product is commonly referred to as fully calcined kaolin. Additional calcination may cause formation of mullite which is a very stable aluminium silicate.

Methods for making metakaolin are long established and well known to those skilled in the art. The furnace, kiln or other heating apparatus used to effect calcining of the hydrous kaolin may be of any known kind. Calcination of the hydrous kaolin takes place, preferably, in an oxidising atmosphere. A typical procedure involves heating kaolin in a kiln, for example a conventional rotary kiln. Typically, the kaolin may be introduced into the kiln as an extrudate from a pug mill. As the kaolin proceeds through the kiln, typically at a starting moisture content of about 25% by weight to facilitate the extrusion of the kaolin, the extrudate breaks down into pellets as a result of the calcination process. A small amount of a binder (such as alum) may be added to the kaolin to provide “green strength” to the kaolin so as to prevent the kaolin from completely breaking down into powder form during the calcination process. The temperature within the kiln should be within a specified range, typically above about 850° C. but not greater than about 950° C. At approximately this temperature (i.e., 950° C.), any amorphous regions of metakaolin begin to re-crystallize.

The period of time for calcination of kaolin to produce metakaolin is based upon the temperature in the kiln to which the kaolin is subjected. Generally, the higher the temperature, the shorter the calcination time, and conversely, the lower the temperature, the higher the calcination time.

The calcination process used may be soak calcining, i.e. wherein the hydrous kaolin or clay is calcined for a period of time during which the chemistry of the material is gradually changed by the effect of heating. The calcining may for example be for a period of at least 1 minute, in many cases at least 10 minutes, e.g. from 30 minutes to five or more hours. Known devices suitable for carrying out soak calcining include high temperature ovens, rotary kilns and vertical kilns. Alternatively, the calcination process may be flash calcining, wherein the hydrous kaolin is typically rapidly heated over a period of less than one second, e.g. less than 0.5 second. Flash calcination refers to heating a material at an extremely fast rate, almost instantaneously. The heating rate in a flash calciner may be of the order of 56,000° C. per second or greater, such as about 100,000° C. to about 200,000° C. per second. It is particularly preferred that the metakaolin is prepared by flash calcination, wherein the clay may be exposed to a temperature greater than 500° C. for a time not more than 5 seconds. Preferably, the clay is calcined to a temperature in the range of from 550° C. to 1200° C.; for microsecond periods the temperature may be as high as 1500° C. More preferably the clay is calcined to a temperature in the range of from 800° C. to 1100° C.; even more preferably a temperature in the range of from 900° C. to 1050° C.; most preferably a temperature in the range of from 950° C. to 1000° C. Preferably, the clay is calcined for a time less than 5 seconds; more preferably for less than 1 second; even more preferably for less than 0.5 seconds; most preferably for less than 0.1 second. Flash calcination of kaolin particles gives rise to relatively rapid blistering of the particles caused by relatively rapid dehydroxylation of the kaolin. Water vapour is generated during calcination which may expand extremely rapidly, in fact generally faster than the water vapour can diffuse through the crystal structure of the particles. The pressures generated are sufficient to produce sealed voids as the interlayer hydroxyl groups are driven off, and it is the swollen interlayer spaces, voids, or blisters between the kaolin platelets which typify flash calcined kaolins and give them characteristic properties.

The flash calcination process may be carried out by injecting the kaolin clay into a combustion chamber or furnace wherein a vortex may be established to rapidly remove the calcined clay from the combustion chamber. A suitable furnace would be one in which a toroidal fluid flow heating zone is established such as the device described in WO 99/24360 and corresponding applications U.S. Pat. No. 6,334,894 and U.S. Pat. No. 6,136,740 the contents of which are herein incorporated by reference.

Any type of metakaolin is suitable for use in the calcination process according to the present invention. Particular examples of metakaolins suitable for use in the present invention include commercially available (from Imerys) Metastar™, Metastar 402 and 501™, Opacilite™, Polestar 501™ According to the present invention, the metakaolin may advantageously possess 12 to 18 wt % of alumina as ascertained by acid solubility testing. A suitable method involves the extraction of soluble aluminium into concentrated nitric acid (Analar grade) and the concentration of aluminium in solution is determined by Inductively Coupled Plasma Atomic Emission Spectroscopy (ICP-AES) using a Thermo Electron Iris-AP Emission Spectrometer and 1000 ppm Al Merck BDH Spectrosol standard solution.

### The Secondary Calcination Process

The metakaolin is subjected to a further or secondary calcination process. The furnace, kiln or other heating apparatus used to effect this secondary calcination may be of any known kind. In particular, this secondary process may be carried out using the standard calcining techniques described above in relation to the formation of the metakaolin. A typical procedure involves heating the metakaolin in a kiln, for example a conventional rotary kiln. Examples of suitable equipment include indirect rotary calciners and direct fired calciners. In the present invention, the use of a direct fired calciner is preferred. Typically, the metakaolin may be calcined at temperatures from about 850 to 1050° C., preferably 925 to 975° C. with a residence time of between 10 and 60 minutes, preferably 30 minutes. The secondary calcination is carried out under reducing conditions. The reducing conditions may be effected by controlling the relative proportions of particular gases in the gaseous atmosphere in the calcining equipment in order to control the combustion process to conditions close to stoichiometric combustion. For example, the relative amount of oxygen gas in the gaseous atmosphere, which may initially comprise mainly methane and air, may be suitably reduced and/or the relative amounts of reducing gases, such as carbon monoxide may be increased. A preferred gaseous reducing atmosphere comprises low levels of oxygen, typically about 5% or less by volume, more particularly about 2% or less by volume and elevated levels of carbon monoxide, for example in the range of 100 to 2000 ppm and preferably with levels in the range of about 500 to 1000 ppm. The gaseous reducing atmosphere may comprise about 1% to 5% by volume of oxygen.

Preferably, the feed metakaolin is mixed with a secondary fuel prior to and/or during the secondary calcination process. Examples of such secondary fuels are carbon, which is usually in the form of charcoal and is usually intimately mixed with the metakaolin prior to the secondary calcination. Both solid and liquid carbon sources may be used. Other suitable examples of secondary fuels include sawdust, fuel oil and vegetable oils.

For solid carbon sources the carbon source and metakaolin may be mechanically blended with a high-shear mixer such as a paddle mixer or a Winkworth blender and this blended material may be added directly to the kiln. Amounts of up to about 3 wt % of carbon material may be used, though amounts up to 2-2.5 wt % are generally sufficient.

For liquid carbon sources, high shear mixers may be used to coat the metakaolin with organic material. The coated material may be left for a short period of time, for example about 5 minutes, in order to allow the organic material to adsorb to the surface of the metakaolin. The coated metakaolin may then be fed into the kiln for the secondary calcination process. As for solid carbon sources, amounts of up to about 3 wt % of carbon material may be used, though amounts up to 2-2.5 wt % are generally sufficient.

### Further Brightening of the Calcined Metakaolin

The calcined metakaolin may be subjected to further processes in order to increase its brightness. For example, the calcined metakaolin may be subjected to bleaching techniques, including any of the known bleaching techniques suitable for bleaching kaolin or metakaolin.

The bleaching of uncalcined kaolins is a well known process and generally those processes suitable for use in bleaching uncalcined kaolins are also suitable for use in the present invention. Particularly preferred for the present invention, is the use of reductive bleaching. In general, with regard to the bleaching of kaolins, the function of reductive bleaching is to remove some or all of the surface iron staining from the kaolin in order to enhance its brightness. The procedure according to the present invention may be carried out in an aqueous suspension of the calcined metakaolin which is usually acidic and, following bleaching, the slurry containing the bleached calcined metakaolin may be filtered to remove the dissolved iron. For the bleaching process according to the present invention, a reducing agent dose rate of about 5 parts per thousand (which is by convention expressed as kg per tonne (kg/t)) by weight of dry metakaolin is sufficient to produce a maximum brightness value. For routine applications, this dose rate is appropriate but there will be instances apparent to the skilled person when bleaching at other dose rates will be necessary. Typically, the amount of reducing agent dose rate will be in the range of about 0.25 to 3.5 kg/t, with the optimal dose rate being about 2.0 to 2.5 kg/t. The amount is typically dependent on the nature of the clay being bleached and any discolouring species present. At various stages in the bleaching process it may be necessary to control the pH of the aqueous slurry. The preferred pH at the various stages of the bleaching process may vary; however, in general, prior to adding the bleaching agent, the pH of the solution is acidic and preferably less than 3. Most preferably, the pH of the slurry will be 2.8+/−0.1. Suitable methods for measuring and adjusting the pH of the aqueous slurry will be readily apparent.

Examples of suitable bleaching agents are typically the same as those used to bleach uncalcined kaolin and will therefore be well known to those skilled in the art. The bleaching agent may be added to the aqueous calcined metakaolin slurry either as a solid or in aqueous solution. A particularly preferred bleaching agent is sodium hydrosulphite for example, of approximately 5% w/v or sodium dithionite, FAS or sodium borohydride.

The metakaolin used in the secondary calcination process according to the present invention may already have been bleached using conventional bleaching methods on uncalcined kaolin.

### Uses of the Metakaolin Products

The metakaolin products, according to the present invention may be mixed with other pigments, fillers and extenders to obtain a blend of properties provided by the constituents of the mixture. The other pigment, filler or extender material may, for example, comprise titanium dioxide, calcium carbonate (ground or precipitated), kaolin, talc, gypsum or other known particulate mineral material, the other material being selected according to the application in which the metakaolin products of the present invention are to be used.

Hence, the calcined metakaolin made according to the methods of the present invention and the high brightness, low yellowness, low relative density metakaolin according to the second aspect of the present invention are suitable for use in a broad range of applications. Broadly, these metakaolin products may be employed as pigment additives in filler and coating compositions suitable for use in paper, inks, polymers, rubbers, barrier coatings, ceramics, paper coatings, paints and the like.

### (a) Polymer Products

The metakaolin products according to the present invention may be incorporated in polymer products and are typically present at a concentration of up to 60% by weight of the polymer as compounded and up to 30% by weight of the final polymer article. In addition to their role as pigments, the metakaolin products can be used both for resin extension (i.e., filling), TiO₂ extension, and reinforcement of the polymer. The polymer product comprises at least one polymer resin. The term resin means a polymeric material, either solid or liquid, prior to shaping into a plastic article. The at least one polymer resin is one which, on cooling (in the case of thermoplastic plastics) or curing (in the case of thermosetting plastics), can form a plastic material. The at least one polymer resin, can be chosen, for example, from polyolefin resins, polyamide resins, polyester resins, engineering polymers, allyl resins, thermoplastic resins, and thermoset resins.

The metakaolin products of the present invention may be combined with a polymer resin to form a polymer composition from which a shaped article is subsequently formed. “Polymer resin” is the general term used in the plastics art to denote a polymeric material (solid or liquid) prior to shaping into a plastic article. In the case of thermoplastic polymers, the polymer resin is melted (or otherwise softened) prior to formation of an article, usually by a moulding process, and the polymer will not normally be subjected to any further chemical transformations. After formation of the shaped article, the polymer resin is cooled and allowed to harden. In the case of thermosetting polymers, the polymer resin is in a precursor state which, after shaping, is cured to obtain the final polymeric article. In the curing stage, chemical crosslinks are formed. The metakaolin products of the present invention are suited for use with polymer resins which are thermoplastic in nature or to polymer resins in which the resin is thermosetting.

The polymer resin composition may be made by methods which are well known in the art generally in which a metakaolin product of the present invention and the polymer resin are mixed together in suitable ratios to form a blend (so-called “compounding”). In general, the polymer resin should be in a liquid form to enable the particles of the filler to be dispersed therein. Where the polymer resin is solid at ambient temperatures, therefore, the polymer resin will need to be melted before the compounding can be accomplished. In some embodiments, a metakaolin product according to the present invention may be dry blended with particles of the polymer resin, dispersion of the particles in the resin then being accomplished when the melt is obtained prior to forming an article from the melt, for example in an extruder itself.

In embodiments of the invention, the polymer resin and a metakaolin product and, if necessary, any other optional additives, may be formed into a suitable masterbatch by the use of a suitable compounder/mixer in a manner known per se, and may be pelletized, e.g. by the use of a single screw extruder or a twin-screw extruder which forms strands which may be cut or broken into pellets. The compounder may have a single inlet for introducing the filler and the polymer together. Alternatively, separate inlets may be provided for the filler and the polymer resin. Suitable compounders are available commercially, for example from Werner & Pfleiderer. Examples of suitable additives include pigments other than those according to the present invention, antioxidants, processing aids, light stabilisers and glass fibre.

The polymer resin compositions incorporating a metakaolin product of the present invention can be processed to form, or to be incorporated in, articles of commerce in any suitable way. Such processing may include compression moulding, injection moulding, gas-assisted injection moulding, calendaring, vacuum forming, thermoforming, extrusion, blow moulding, drawing, spinning, film forming, laminating or any combination thereof. Any suitable apparatus may be used, as will be apparent to one of ordinary skill in this art.

The articles which may be formed from the polymer compositions are many and varied. Examples include films, engineering thermoplastics and PVC cables.

### (b) Paints

The metakaolin products according to the present invention may be used in paints, such as an aqueous or non-aqueous industrial coating, architectural paint, deco paint, or art paint, comprising, in an appropriate medium, a metakaolin product of the present invention. The metakaolin products disclosed herein can serve, for example, as gloss control agent pigments in the paint. The metakaolin product will generally be present in an amount less than the critical pigment volume. However, the metakaolin product of the present invention can also be present in higher pigment volume concentrations, such as for example in the range of 1% to 80% by weight on a dry film basis. The paint will typically further comprise at least one component chosen from binders, such as polymeric binders, for example, water dispersible binders chosen, for example, from polyvinyl alcohol (PVA) and latex; and additives conventionally used in paints, chosen, for example, from surfactants, thickeners, biocides, defoamers, wetting agents, dispersants, and coalescents. The paint may comprise at least one additional pigment chosen, for example, from TiO₂ and calcium carbonate.

### (c) Inks

The metakaolin products according to the present invention are suitable for use as pigments in aqueous inks and non-aqueous inks, including, for example, gravure inks, heat-set inks, lithographic printing inks, and newsprint inks. Depending on the final applications of the ink, the ink may further comprise at least one component chosen, for example, from resins, such as vinyl resins; polymers; additives, such as rheology modifiers, surfactants, and drying accelerating agents such as sodium lauryl sulfate, N,N-diethyl-m-toluamide, cyclohexylpyrrolidinone and butyl carbitol; fillers; diluents; humectants, such as ethylene glycol, propylene glycol, diethylene glycols, glycerine, dipropylene glycols, polyethylene glycols, polypropylene glycols, amides, ethers, carboxylic acids, esters, alcohols, organosulfides, organosulfoxides, sulfones, alcohol derivatives, carbitol, butyl carbitol, cellosolve, ether derivatives, amino alcohols, and ketones; and biocides, such as benzoates, sorbates, and isothiazolones. The ink product can further comprise at least one additional pigment chosen from those conventionally used in the art. The amount of metakaolin product in a given ink can vary greatly, based on the formulation of the ink, as would be apparent to one of ordinary skill in the art. For example, the metakaolin product can comprise from 5%-45% by weight of the ink as formulated.

### (d) Rubber Products

The metakaolin products according to the present invention may be incorporated into a rubber composition. The metakaolin may, for example, be used as a filler or an extender in the rubber composition. The composition comprising the metakaolin prepared according to the present invention can provide the benefits of resin extension, reinforcement and increased hardness of the rubber composition. The rubber product disclosed herein comprises at least one rubber chosen from natural rubbers and synthetic rubbers. For example, sulphur-vulcanisable rubbers, which can be used for the manufacture of tyre treads. Examples of the synthetic rubbers, which may be used in the present invention, include, but are not limited to, styrene-butadiene rubber (SBR), vinyl-styrene-butadiene rubber (VSBR), butadiene rubber (BR), and neoprene rubber or polyisoprene. The SBR may be emulsion SBR (E-SBR) or solution SBR(S-SBR). The VSBR may be solution VSBR(S-VSBR). Examples of the BR include, cis-1,3-polybutadiene rubber and cis-1,4-polybutadiene rubber. An example of the natural rubbers, which the metakaolin products of the present invention can be used in is Standard Malaysian natural rubber. The rubber products may further comprise at least one additive chosen from conventional additives used in the art, for example, extender oils and mineral and synthetic fillers. The rubber can include an amount of the metakaolin product to about 35% by weight as formulated.

### (e) Paper Products

The term paper products should be understood to mean all forms of paper, including board, card, paperboard, and the like.

The metakaolin products according to the present invention may be blended in various proportions with conventional filler materials, e.g. precipitated or ground calcium carbonate, kaolin and other clay minerals, metakaolin not produced according to the present invention, talc, calcium sulphate, the ingredients and composition being selected according to the quality of the paper required to be produced. In general, these materials are likely to be in a slurry form when they are mixed. The metakaolin products according to the present invention can be used in the preparation of a paper making composition or a paper coating composition. The paper making composition may typically comprise, in aqueous suspension and in addition to the metakaolin product of the present invention, cellulosic fibres and other conventional additives known in the art. A typical paper making composition would contain up to about 67% by weight of dry filler material based on the dry weight of the paper making fibres and may also contain a cationic or an anionic retention aid in an amount in the range from 0.1 to 2% by weight, based on the dry weight of the filler material. It may also contain a sizing agent which may be, for example, a long chain alkylketene dimer, a wax emulsion or a succinic acid derivative. The composition may also contain dye and/or an optical brightening agent.

A paper coating composition will contain, in aqueous or non-aqueous suspension, and in addition to a metakaolin product according to the present invention, optionally, other filler materials, a binder chosen from binders conventionally used in the art. Exemplary binders include but are not limited to adhesives derived from natural starch and synthetic binders. The formula of the paper coating composition will depend upon the purpose for which the coated paper is to be used, i.e., either for offset or gravure printing. Generally speaking, the amount of adhesive will be in the range from 3 to 35% by weight of adhesive solids, based on the dry weight of the coating. There will also be present from 0.01 to 0.5% by weight, based on the dry weight of the coating, of a dispersing agent. Sufficient alkali will generally be added to raise the pH to about 8-9. The adhesive solids may be a starch, a water dispersible synthetic resin or latex such as a styrene butadiene copolymer, a polyvinyl alcohol, an acrylic, polyvinyl acetate, a butadiene-acrylonitrile copolymer, a cellulose derivative such as methyl cellulose, sodium carboxymethyl cellulose or hydroxyethyl cellulose or a proteinaceous material such as casein, animal glue or a vegetable protein. Paper coatings may include a metakaolin product of the present invention in an amount ranging from about 3% to about 95% by weight on a dry coating basis.

Calendering is a well known process in which paper smoothness and gloss is improved and bulk is reduced by passing a coated paper sheet between calender nips or rollers one or more times. Usually, elastomer coated rolls are employed to give pressing of high solids compositions. An elevated temperature may be applied. One or more (e.g. up to about 12, or sometimes higher) passes through the nips may be applied. Methods of coating paper and other sheet materials, and apparatus for performing the methods, are widely published and well known. Such known methods and apparatus may conveniently be used for preparing coated paper. For example, there is a review of such methods published in Pulp and Paper International, May 1994, page 18 et seq. Sheets may be coated on the sheet forming machine, i.e., “on-machine,” or “off-machine” on a coater or coating machine. Use of high solids compositions is desirable in the coating method because it leaves less water to evaporate subsequently. However, as is well known in the art, the solids level should not be so high that high viscosity and leveling problems are introduced. The methods of coating may be performed using apparatus comprising (i) an application for applying the coating composition to the material to be coated; and (ii) a metering device for ensuring that a correct level of coating composition is applied. When an excess of coating composition is applied to the applicator, the metering device is downstream of it. Alternatively, the correct amount of coating composition may be applied to the applicator by the metering device, e.g., as a film press. At the points of coating application and metering, the paper web support ranges from a backing roll, e.g., via one or two applicators, to nothing (i.e., just tension). The time the coating is in contact with the paper before the excess is finally removed is the dwell time—and this may be short, long or variable.

The coating is usually added by a coating head at a coating station. According to the quality desired, paper grades are uncoated, single coated, double coated and even triple coated. When providing more than one coat, the initial coat (precoat) may have a cheaper formulation and optionally less pigment in the coating composition. A coater that is applying a double coating, i.e. a coating on each side of the paper, will have two or four coating heads, depending on the number of sides coated by each head. Most coating heads coat only one side at a time, but some roll coaters (e.g., film press, gate roll, size press) coat both sides in one pass.

Examples of known coaters which may be employed include, without limitation, air knife coaters, blade coaters, rod coaters, bar coaters, multi-head coaters, roll coaters, roll/blade coaters, cast coaters, laboratory coaters, gravure coaters, kisscoaters, liquid application systems, reverse roll coaters, curtain coaters, spray coaters and extrusion coaters.

Water may be added to the solids comprising the coating composition to give a concentration of solids which is preferably such that, when the composition is coated onto a sheet to a desired target coating weight, the composition has a rheology which is suitable to enable the composition to be coated with a pressure (e.g. a blade pressure) of between 1 and 1.5 bar.

### (f) Barrier Coatings

The metakaolin products according to the present invention may be incorporated into barrier coating compositions which comprise a slurry comprising the metakaolin. Typically, the solids content of the slurry ranges from about 45% to about 70% by wt. Barrier coatings are generally useful in imparting to paper, moisture resistance, moisture vapour resistance, and resistance to grease, oil, air and the like. The amount of binder in the barrier coating may be in the range of about 40% to 50% by wt.

### (g) Ceramics

The metakaolin products according to the present invention may be incorporated into ceramic forming compositions. Ceramic articles are generally formed from a wet high solids composition which comprises a blend of various particulate ingredients which includes kaolinitic clays, i.e. clays which contain the mineral kaolinite. Often, fluxing materials such as china stone, feldspar or nepheline syenite and at least one silica containing material such as quartz or flint are included in such compositions. For the production of bone china the composition will also contain a substantial proportion of ground calcined animal bone. The composition may also include minor proportions of other ingredients such as calcium carbonate, dolomite and talc. The proportions of the various ingredients used in the composition will vary according to the properties in the fired ceramic article. Prior to firing the ceramic forming composition, it is shaped and dried. The ceramic forming composition will need to have sufficient plasticity to enable it to be shaped and it must also possess sufficient strength in its unfired or “green” state to permit a certain amount of handling without loss of its integrity and shape.

### EXAMPLES

Embodiments of the present invention will now be described by way of example only with reference to the following examples.

### Test Methods

### Brightness (ISO)

The ISO brightness is the percentage of light reflected by a body compared to that reflected by a perfectly reflecting diffuser measured at 457 nm. A Datacolour Elrepho fitted with two tungsten lamps, a gloss shield and a range of filters which includes one at a nominal setting of 457 nm and one at a nominal setting of 571 nm was used.

A test surface is produced by pulverizing a dried material, for example using an Imerys pulveriser, to disperse it completely then compressing it under a pressure of 1.2 kg cm⁻² to form a powder tablet. Drying is carried out in an oven and dryness of the sample is denoted by the absence of condensation on a piece of cool plate glass when placed in close proximity to the surface of the sample which has been removed from the oven. Suitable drying ovens include the forced circulation type which are capable of maintaining a temperature of 80° C. to within 5° C.

The reflectance values of this tablet are measured at two wavelengths in the visible spectrum. The measurements were made with the ultraviolet component excluded. The primary standard adopted was an ISO level 2 reflectance standard, supplied and calibrated by Physikalisch-Technische Bundesanstalt (P.T.B.) West Germany. A working standard, in this case a ceramic tile, was used to calibrate the photometer for brightness measurements which had been calibrated previously against the level 2 standard.

### Yellowness (YEL)

The yellowness was measured according to the procedure described above for the brightness measurements. The yellowness is reported as the value obtained when the reflectance at 457 nm is subtracted from the reflectance at 571 nm.

### Whiteness (WHI)

The whiteness was measured according to the CIE standard codified by ISO 11475:1999 and Determination of CIE whiteness, D65/10 degrees (outdoor daylight).

### Test Materials

Samples A and B are virtually pure metakaolins (flash calcined) produced from the Imerys Opacilite™ production route using selected feeds. The soluble alumina levels in each sample lie in the range of about 17.5 to 17.8 wt %. Data relating to the test materials may be found in Tables 1 to 4 (feed). In addition, Sample A possesses a sub 2 μm content of 63 wt % and has a surface area of 15.0 m²g⁻¹ and Sample B possesses a sub 2 μm content of 60 wt % and a surface area of 14.8 m²g⁻¹. The sub 2 μm measurements are made according to esd measurements (sedigraph) and the surface area measurements are as measured by the BET liquid nitrogen absorption method (ISO 5794/1).

### Calcination of Metakaolin

### (A) Indirect Rotary Calciner Method

Secondary calcination experiments were carried out on metakaolins Sample A and Sample B in an indirect rotary calciner operating at 20 kg/hour with a residence time of approximately 40 minutes. Experiments were carried out according to the present invention under reductive conditions and for the purposes of comparison, experiments were carried out under oxidative conditions.

The results are presented in Tables 1 and 2 for Sample B and Tables 3 and 4 for Sample A.

TABLE 1
(reductive)

| | | | | | Specific |
|---|---|---|---|---|---|
| Sample | Temp/° C. | ISO | YEL | WHI | Gravity |
| Sample B | — | 76.0 | 2.8 | 68.2 | 2.10 |
| (Feed) | | | | | |
| Sample B | 900 | 83.6 | 6.2 | 85.4 | 2.04 |
| Sample B | 950 | 84.4 | 6.4 | 87.0 | 2.05 |
| Sample B | 1000 | 85.7 | 6.3 | 89.5 | 2.05 |
| Sample B | 1050 | 87.8 | 6.1 | | 2.13 |

TABLE 2
(oxidative)

| | | | | Specific |
|---|---|---|---|---|
| Sample | Temp/° C. | ISO | YEL | Gravity |
| Sample B | — | 76.0 | 2.8 | 2.10 |
| (Feed) | | | | |
| Sample B | 850 | 82.6 | 6.0 | 2.10 |
| Sample B | 900 | 82.9 | 6.1 | 2.10 |
| Sample B | 950 | 84.2 | 6.5 | 2.08 |
| Sample B | 1000 | 85.5 | 6.2 | 2.07 |
| Sample B | 1050 | 87.8 | 5.8 | 2.14 |

TABLE 3
(reductive)

| | | | | Specific |
|---|---|---|---|---|
| Sample | Temp/° C. | ISO | YEL | Gravity |
| Sample A (feed) | — | 86.9 | 3.4 | 2.07 |
| Sample A | 950 | 91.9 | 2.9 | 2.07 |

TABLE 4
(oxidative)

| | | | | Specific |
|---|---|---|---|---|
| Sample | Temp/° C. | ISO | YEL | Gravity |
| Sample A | — | 86.9 | 3.4 | 2.07 |
| (Feed) | | | | |
| Sample A | 850 | 89.1 | 4.8 | 2.03 |
| Sample A | 900 | 89.2 | 4.8 | 2.03 |
| Sample A | 950 | 90.4 | 4.7 | 2.00 |
| Sample A | 1000 | 90.6 | 4.2 | 2.04 |
| Sample A | 1050 | 92.0 | 3.6 | 2.08 |

### (B) Direct Fired Calciner Method

Secondary calcination experiments were carried out in a direct fired calciner. In this calciner, the refractory lined rotating shell has no lifting flights. Forward flow of the material is effected by the slope and rotation of the shell. A gas or oil burner located at the discharge end enables temperatures of up to about 1650° C. to be achieved. The atmosphere within the kiln may be controlled to give oxidising or reducing conditions. At a feed rate of 10 kg/hour the residence time was about 30 minutes. At other feed rates the angle of the calciner could be adjusted so that the volume within the calciner was kept at approximately the same level. Typically, the residence time of the metakaolin being subjected to secondary calcination was 60 minutes at a feed rate of 5 kg/hour and 20 minutes at a feed rate of 15 kg/hour.

The effect of adding charcoal to the metakaolin is also shown in Tables 5 and 7. In Tables 5 to 7 below, the feed rate was 10 kg/hour. The charcoal used was a standard laboratory grade Carbon Black, Cabot Elftex™ 415, commercially available from Cabot Corporation, Boston, Mass.

The atmosphere of the kilns comprised an amount of air and an amount of other gas or gases, for example natural gas. By controlling the ratio of air to gas, the flame conditions in the kilns could be adjusted. By reducing the air to gas ratio the atmosphere in the kilns will be such that there is just enough air to support the combustion reaction, below this critical point the gas combustion product will comprise carbon monoxide. This carbon monoxide will react with iron (III) species present in the form of iron oxide, scavenging the oxygen thus reducing the iron III species to iron (II) species. Typical or standard operating conditions, which will result in oxidative conditions, require an excess of air, typically about five or six times as much air as would be required to react with the other gas or gases present.

TABLE 5
(reductive)

| | | | | Specific |
|---|---|---|---|---|
| Sample | Temp/° C. | ISO | YEL | Gravity |
| Sample B (Feed) | — | 76.0 | 2.8 | 2.10 |
| Sample B | 900 | 86.0 | 6.0 | 2.02 |
| Sample B | 950 | 86.5 | 6.0 | 2.03 |
| Sample B | 950 | 89.0 | 3.0 | 2.14 |
| (+3 wt % charcoal) | | | | |
| Sample B | 1000 | 87.3 | 6.1 | 2.13 |
| Sample B | 1050 | 89.2 | 5.1 | 2.13 |

TABLE 6
(oxidative)

| | | | | Specific |
|---|---|---|---|---|
| Sample | Temp/° C. | ISO | YEL | Gravity |
| Sample B | — | 76.0 | 2.8 | 2.10 |
| (Feed) | | | | |
| Sample B | 900 | 85.0 | 5.8 | 2.07 |
| Sample B | 950 | — | — | 2.09 |
| Sample B | 1000 | 86.4 | 6.4 | — |
| Sample B | 1050 | 88.5 | 5.1 | — |

TABLE 7
(reductive)

| | | | | Specific |
|---|---|---|---|---|
| Sample | Temp/° C. | ISO | YEL | Gravity |
| Sample A (Feed) | — | 86.9 | 3.4 | 2.07 |
| Sample A | 950 | 91.9 | 3.7 | — |
| Sample A | 950 | 91.9 | 2.9 | 2.07 |
| (+3 wt % Charcoal) | | | | |

The effect of feed rate was investigated under reductive conditions in a direct fired calciner. The results are shown in Table 8.

TABLE 8

| | | Feed rate/ | | | Specific |
|---|---|---|---|---|---|
| Sample | Temp/° C. | kg/hr | ISO | YEL | Gravity |
| Sample B | — | — | 76.0 | 2.8 | 2.10 |
| (Feed) | | | | | |
| Sample B | 950 | 5 | 87.6 | 6.0 | 2.14 |
| Sample B | 950 | 10 | 86.5 | 6.0 | 2.03 |
| Sample B | 950 | 15 | 86.6 | 6.3 | |

### Bleaching of the Calcined Metakaolin

Table 9 shows the effects of bleaching Sample B and Sample A following secondary calcination at 950° C. in an indirect rotary calciner. For the purposes of comparison, results are also included wherein no secondary calcination and/or subsequent bleaching has been performed.

Bleaching was carried out by adding 20 g+/−0.1 g of the metakaolin to 100 ml of deionised water in an homogeniser pot or beaker. Dispersion of the metakaolin was carried out for about 1 minute with the homogeniser or at least 3 minutes with the stirrer. The aqueous sample was mixed to homogeniety with the bench stirrer or alternatively rotating rollers and the density measured. The pH of the slurry was measured using a pH meter buffered to pH 4 and adjusted to pH 2.8+/−0.1 with either 4% w/v sulphuric acid or 5% w/v sodium carbonate and stirring. The sodium hydrosulphite solution was added to the slurry in an amount equivalent to 4 kg/tonne. Thorough mixing was carried out in order to avoid air entrainment. The pH of the slurry was readjusted to 2.8+/−0.1 using 4% w/v sulphuric acid. After a further 2 minutes the pH was again readjusted to 2.8+/−0.1. The slurry was allowed to stand for approximately a further 8 minutes without stirring. The pH was then adjusted to between 4 and 4.5 with 5% w/v sodium carbonate, whilst stirring with a rod to ensure complete mixing, followed by immediate filtration. The sample was dried at 80° C. and tested.

TABLE 9

| | Secondary | | | |
|---|---|---|---|---|
| Sample | Calcined | Bleached | ISO | YEL |
| Sample B | No | No | 76.0 | 2.8 |
| Sample B | No | Yes | 77.1 | 2.3 |
| Sample B | Yes | No | 84.2 | 6.5 |
| Sample B | Yes | Yes | 84.5 | 6.1 |
| Sample A | No | No | 86.9 | 3.4 |
| Sample A | No | Yes | 88.6 | 2.5 |
| Sample A | Yes | No | 90.4 | 4.7 |
| Sample A | Yes | Yes | 90.7 | 4.3 |

### CONCLUSIONS

The methods of the present invention result in metakaolins with increased brightness, and acceptable (at least) yellowness and are suitable for producing high brightness, low yellowness, low relative density metakaolins.

1. A method of increasing the brightness of a metakaolin comprising calcining the metakaolin in a reducing atmosphere.

2. A method according to claim 1, wherein the calcination takes place in a kiln, furnace or other heating apparatus.

3. A method according to claim 2, wherein the calcination takes place in a rotary kiln.

4. A method according to claim 1, wherein the calcination of the metakaolin takes place in the presence of a secondary fuel.

5. A method according to claim 4, wherein the secondary fuel is selected from one or more of carbon, fuel oil, sawdust, vegetable oil.

6. A method according to claim 5, wherein the secondary fuel is carbon.

7. A method according to claim 6, wherein the secondary fuel is charcoal.

8. A method according to claim 1, wherein the calcining of the metakaolin takes place at a temperature from about 850 to about 1050° C.

9. A method according to claim 8, wherein the temperature range is about 925 to about 975° C.

10. A method according to claim 2, wherein the residence time of the metakaolin in the kiln, furnace, or heating apparatus is between about 10 and about 60 minutes.

11. A method according to claim 1, wherein the reducing atmosphere is produced from a mixture comprising methane and air and the combustion process is close to or at stoichiometric combustion.

12. A method according to claim 1, wherein the reducing atmosphere comprises about 5% or less by volume of oxygen and about 100 to about 2000 ppm of carbon monoxide.

13. A method according to claim 12, wherein the reducing atmosphere comprises about 2% or less by volume of oxygen.

14. A method according to claim 12, wherein the reducing atmosphere comprises about 500 to about 1000 ppm of carbon monoxide.

15. A method according to claim 12, wherein the reducing atmosphere comprises about 1% to about 5% by volume of oxygen.

16. A method according to claim 1, further comprising subjecting the calcined metakaolin to comminution.

17. A method according to claim 16, wherein the calcined metakaolin is ground or milled.

18. A method according to claim 1, wherein the calcined metakaolin is at least 0.3 ISO units brighter than the metakaolin prior to calcination.

19. A method according to claim 18, wherein the calcined metakaolin is at least 0.5 ISO units brighter than the metakaolin prior to calcination.

20. A method according to claim 19, wherein the calcined metakaolin is at least 1.0 ISO units brighter than the metakaolin prior to calcination.

21. A method according to claim 20, wherein the calcined metakaolin is at least 2.0 ISO units brighter than the metakaolin prior to calcination.

22. A method according to claim 21, wherein the calcined metakaolin is at least 3.0 ISO units brighter than the metakaolin prior to calcination.

23. A method according to the preceding claim 22 wherein the calcined metakaolin is at least 5.0 ISO units brighter than the metakaolin prior to calcination.

24. A method according to claim 1, further comprising bleaching the calcined metakaolin.

25. A method according to claim 24, wherein during bleaching the calcined metakaolin is in the form of a dispersed aqueous slurry.

26. A method according to claim 24, wherein the calcined metakaolin is bleached using a reductive bleaching agent.

27. A method according to claim 26, wherein the reductive bleaching agent is selected from sodium dithionite, sodium hydrosulphite, formamidine sulphinic acid, borohydride and a combination of formamidine sulphinic acid and borohydride.

28. A method according to claim 26, wherein the amount of reductive bleaching agent is about 0.25 to about 3.5 kg per tonne of calcined metakaolin.

29. A method according to claim 24, further comprising, following bleaching, filtering and drying the bleached calcined metakaolin.

30. A method according to claim 29, wherein drying is carried out at a temperature range of 50 to 600° C.

31. A method according to claim 29, further comprising, following drying, subjecting the bleached calcined metakaolin to comminution.

32. A method according to the preceding claim 31, wherein the bleached calcined metakaolin is ground or milled.

33. A method according to 16 or 31, wherein the d50 of the calcined metakaolin or the bleached calcined metakaolin is in the range of 0.1 to 20 μm.

34. A method according to claim 33, wherein the d50 is in the range of 0.1 to 10 μm.

35. A method according to claim 34, wherein the d50 is in the range of 1 to 5 μm.

36. A method according to claim 35, wherein the d50 is about 2.2 μm.

37. A method according claim 24, further comprising, prior to bleaching the calcined metakaolin, adjusting the pH of the calcined metakaolin.

38. A method according to claim 24, further comprising, adjusting the pH of the calcined metakaolin after bleaching the calcined metakaolin.

39. A method according to claim 37 or 38, wherein the pH is made more acidic.

40. A method according to claim 39 wherein the pH lies in the range of 2 to 3.

41. A method according to claim 30 wherein the pH is about 2.8.

42. A method according to claim 39, wherein the pH is made more acidic using any one of phosphoric acid, sulphuric acid or a combination thereof.

43. A method according to claim 37 or 38, wherein the pH is made more alkaline.

44. A method according to claim 39, wherein following acidification the pH is made more alkaline.

45. A method according to claim 43, wherein the pH is made more alkaline using any one of sodium carbonate, sodium hydroxide, calcium hydroxide, calcium carbonate, potassium hydroxide, potassium carbonate or a combination thereof.

46. A method according to claim 1, wherein the metakaolin, prior to calcination, is a flash calcined kaolin or a soak calcined kaolin.

47. A method according to claim 1, wherein the metakaolin, prior to and after calcination, possesses 12 to 18 wt % of alumina as ascertained by acid solubility testing.

48. A method according to claim 1, wherein the yellowness of the calcined metakaolin is at least 0.1 units less than the metakaolin prior to calcination.

49. A calcined metakaolin obtained according to the method of claim 1.

50. A method according to claim 1, further comprising incorporating the calcined metakaolin in to any one of a paper composition, a paper coating composition, an ink composition, a polymer composition, a rubber product, a barrier coating composition, a ceramic composition or a paint composition.

51. A method according to claim 1, further comprising combining the calcined metakaolin with at least one component chosen from resins, polymers, additives, fillers, diluents, humectants, biocides and additional pigments in an ink making process.

52. A method according to claim 1, further comprising blending the calcined metakaolin with one or more of precipitated or ground calcium carbonate, kaolin, clay minerals other than kaolin, talc, calcium sulphate, cellulosic fibres, a retention aid, and a sizing agent in a paper making process.

53. A method according to claim 1, further comprising blending the calcined metakaolin with one or more binders, surfactants, thickeners, biocides, defoamers, wetting agents, dispersants and coalescents and an additional pigment in a paint making process.

54. A method according to claim 1, further comprising mixing the calcined metakaolin with a binder into an aqueous or non-aqueous medium to form a suspension suitable for use as a paper coating composition.

55. A method according to claim 54, further comprising coating a paper product with said paper coating composition followed by calendaring of the coated product.

56. A method according to claim 1, further comprising combining the calcined metakaolin with a rubber and optionally at least one additive chosen from extender oils and mineral and synthetic fillers in a rubber making process.

57. A method according to claim 1, further comprising combining the calcined metakaolin with a binder to form a mixture suitable for use as a barrier coating composition.

58. A method according to claim 1, further comprising incorporating the calcined metakaolin into a ceramic forming composition.

59. A method according to claim 58 further comprising shaping, drying and firing the ceramic forming composition to form a ceramic article.

60. A method according to claim 59, further comprising incorporating the calcined metakaolin in a polymer resin composition.

61. A method according to claim 60, further comprising forming the polymer resin composition into an article.

62. Use of the calcined metakaolin obtained according to claim 49 in any one of a paper composition, a paper coating composition, a paint composition, a polymer composition, an ink composition, a ceramic composition, a barrier coating composition or a rubber product.

63. An ink obtained according to the method of claim 50 or 51.

64. A paper product obtained according to the method of claim 50 or 52.

65. A paint obtained according to the method of claim 50 or 53.

66. A paper coating composition obtained according to the method of claim 50 or 54.

67. A calendered paper product obtained according to the method of claim 55.

68. A rubber product obtained according to the method of claim 50 or 56.

69. A barrier coating composition obtained according to the method of claim 50 or 57.

70. A ceramic forming composition obtained according to the method of claim 50 or 58.

71. A ceramic article obtained according to the method of claim 59.

72. A polymer resin obtained according to the method of claim 50 or 60.

73. An article obtained according to the method of claim 61.

74. A metakaolin having a relative density less than about 2.2, an ISO brightness greater than about 88 and a yellowness less than about 3.5.

75. A metakaolin according to claim 74, wherein the relative density is in the range of 1.95 to 2.15.

76. A metakaolin according to claim 75, wherein the ISO brightness is greater than about 89.

77. A metakaolin according to claim 76, wherein the ISO brightness is greater than about 90.

78. A metakaolin according to claim 77, wherein the ISO brightness is greater than about 90.5.

79. A metakaolin according to claim 74, wherein the yellowness is in the range of 0.1 to 3.

80. A metakaolin according to claim 79, wherein the yellowness is in the range of 1 to 3.

81. A metakaolin according to claim 74, wherein the d50 of the metakaolin is in the range of 0.1 to 20 μm.

82. A metakaolin according to claim 81, wherein the d50 is in the range of 0.1 to 10 μm.

83. A metakaolin according to claim 82, wherein the d50 is in the range of 1 to 5 μm.

84. A metakaolin according to claim 83, wherein the d50 is about 2.2 μm.

85. Use of a metakaolin according to claim 74 in any one of a paper composition, a paper coating composition, a paint composition, a polymer composition, an ink composition, a ceramic composition, a barrier coating composition, a rubber product, a polymer article or a ceramic article.

86. A paper composition, a paper coating composition, a paint composition, a polymer composition, an ink composition, a ceramic composition, a barrier coating composition, a rubber product, a polymer article or a ceramic article comprising a metakaolin according to claim 74.

87. A method according to claim 44, wherein the pH is made more alkaline using any one of sodium carbonate, sodium hydroxide, calcium hydroxide, calcium carbonate, potassium hydroxide, potassium carbonate or a combination thereof.
